(19) United States
(12) Patent Application Publication
(10) Pub. No.: US 2014/0297317 A1
(43) Pub. Date: Oct. 2, 2014

(54) EXTRACTING KEY ACTION PATTERNS FROM PATIENT EVENT DATA

(71) Applicant: INTERNATIONAL BUSINESS MACHINES CORPORATION, Armonk, NY (US)

(72) Inventors: JIANYING HU, BRONX, NY (US); GEETIKA T. LAKSHMANAN, WINCHESTER, MA (US); SZABOLCS ROZSNYAI, NEW YORK, NY (US); FEI WANG, OSSINING, NY (US)

(73) Assignee: INTERNATIONAL BUSINESS MACHINES CORPORATION, Armonk, NY (US)

(21) Appl. No.: 13/851,675

(22) Filed: Mar. 27, 2013

(51) Int. Cl. G06F 19/00

(52) U.S. Cl. CPC G06F 19/322
USPC 705/3

(57) ABSTRACT

Systems and methods for data analysis include determining a patient trace as a set of medical events for a patient. Medical events of the patient trace are grouped into subsets of medical events using a processor according to a temporal relationship between the medical events. Co-occurring events are identified from the subsets of medical events as event clusters. A plurality of medical events in one or more of the subsets of the patient trace is represented using the event clusters to condense the patient trace.

### CROSS-REFERENCE TO RELATED APPLICATIONS

This application is related to commonly assigned U.S. Application Serial No. [TBD], entitled “CLUSTERING BASED PROCESS DEVIATION DETECTION,” Attorney Docket Number YOR920130156US1 (163-649), filed concurrently herewith, and commonly assigned U.S. Application Serial No. [TBD], entitled “EXTRACTING CLINICAL CARE PATHWAYS CORRELATED WITH OUTCOMES,” Attorney Docket Number YOR920130157US1 (163-650), filed concurrently herewith, both of which are incorporated herein by reference in their entirety.

### BACKGROUND

1. Technical Field

The present invention relates to analysis of patient data, and more particularly to extracting key action patterns from patient event data.

2. Description of the Related Art

Identifying patterns from patient event data is an important step not only in studying the nature of diseases, but also for understanding relationships between a specific care pathway and patient outcome. In patient event data, the smallest resolution is typically a day. However, it is very common for multiple events to occur on a same day. These same day events are considered concurrent events, due to the resolution of the patient even data. However, such data characteristics provide a great challenge for existing temporal pattern mining approaches, as all possible combinations of events are to be considered. Existing temporal pattern mining approaches suffer from this problem of pattern explosion. In addition, there is no existing research that relates temporal pattern mining to outcome analysis in the healthcare domain.

### SUMMARY

A method for data analysis includes determining a patient trace as a set of medical events for a patient. Medical events of the patient trace are grouped into subsets of medical events using a processor according to a temporal relationship between the medical events. Co-occurring events are identified from the subsets of medical events as event clusters. A plurality of medical events in one or more of the subsets of the patient trace is represented using the event clusters to condense the patient trace.

A system for data analysis includes a segmentation module configured to group medical events of a patient trace stored on a computer readable storage medium into subsets of medical events according to a temporal relationship between the medical events, the patient traces determined as a set of medical events of a patient. A clustering module is configured to identify co-occurring events from the subsets of medical events as event clusters. An aggregation module is configured to represent a plurality of medical events in one or more of the subsets of the patient trace using the event clusters to condense the patient trace.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for extracting key action patterns, in accordance with one illustrative embodiments;

FIG. 2 shows an event gap based trace segmentation, in accordance with one illustrative embodiments;

FIG. 3 shows a co-occurrence matrix, in accordance with one illustrative embodiment;

FIG. 4 shows the consolidation of consecutive identical events, in accordance with one illustrative embodiment; and

FIG. 5 is a block/flow diagram showing a system/method for extracting key action patterns, in accordance with one illustrative embodiment.

### DETAILED DESCRIPTION OF PREFERRED EMBODIMENTS

In accordance with the present principles, systems and method for extracting key action patterns from patient event data are shown. Patient event data may be stored in an electronic medical record as medical events, such as, e.g., medications, labs, diagnoses, vital signs, etc. Patient traces are constructed as sets of medical events for a patient.

Patient traces may be processed to condense events in a patient trace. Events of a patient trace are segmented into event groups according to a temporal relationship between consecutive events. Segmentation boundaries may be identified between consecutive events, where a temporal gap between the consecutive events meets or exceeds a pre-defined temporal threshold. Event groups are provided as events in a patient trace between segmentation boundaries.

Frequently co-occurring events are identified from the event groups based on clustering. A co-occurrence matrix is formed, where the events of the event groups are represented as both rows and columns of the co-occurrence matrix. Entries of the co-occurrence matrix indicate the frequency of co-occurrence for the events represented by the row and column. Clustering (e.g., by singular value decomposition) is performed on the co-occurrence matrix to determine event clusters. Event clusters are then used to aggregate events in patient traces such that patient traces are reduced.

Patient traces may be further condensed by consolidating consecutive events of a same type, such as, e.g., consecutive identical events. Consolidated repeating events may be distinguished from single events by, e.g., the suffix Rep.

Patterns are then extracted from the patient traces by pattern mining (e.g., sequential pattern mining). Pattern mining often results in too many non-informative patterns. Hierarchical pattern summarization is performed to combine pattern pairs with the same events, such that the dependency order between the same events is ignored. Analysis may continue by performing sparse logistic regression to identify patterns most predictive of an outcome.

One advantage of the present principles is that patient traces are condensed, avoiding the problem of pattern explosion. The present principles may extract care pathway patterns to determine whether they have an impact on positive or negative patient outcomes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

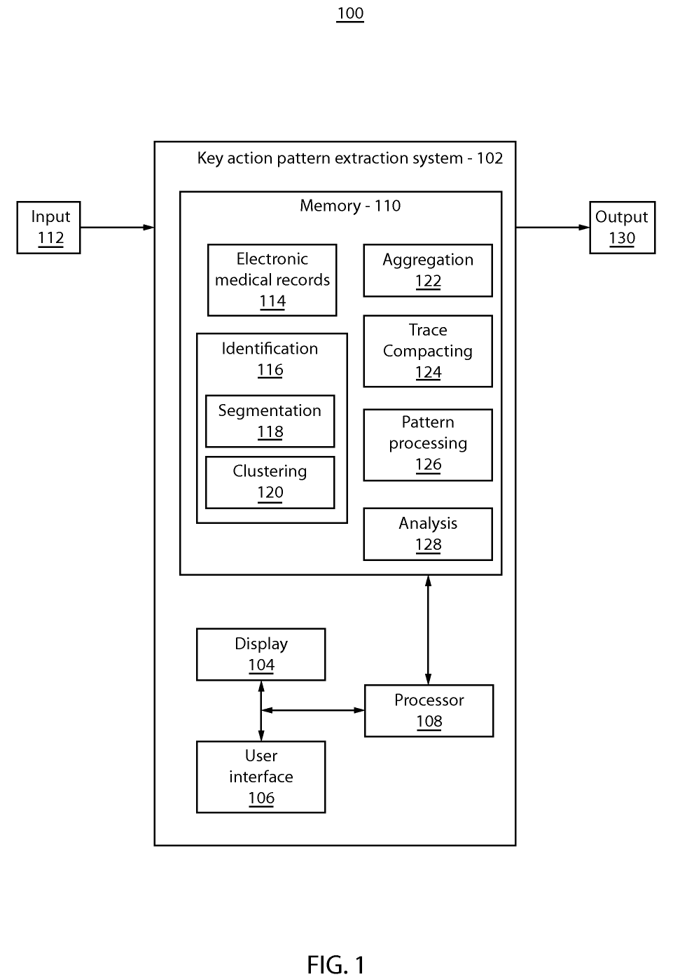

Referring now to the drawings in which like numerals represent the same or similar elements and initially to FIG. 1, a block/flow diagram for a system for extracting key action patterns 100 is illustratively depicted in accordance with one embodiment. The system 100 may analyze data (e.g., patient event data) to identify key action patterns. One goal of the present principles is to identify event patterns that are highly correlated with outcomes. Key action patterns are subsequences extracted from patient event data that are both frequent and discriminative. Key action patterns are frequent in that they appear in patient care pathway traces with a certain frequency (e.g., percentage). Key action patterns are also discriminative in that they are closely correlated to the final outcomes.

While the present principles are described in terms of healthcare, it should be understood that the present principles are not so limited. Rather, other applications are also contemplated within the scope of the present principles, such as, e.g., insurance.

The system 100 may include a system or workstation 102. The system 102 preferably includes one or more processors 108 and memory 110 for storing patient data, applications, modules and other data. The system 102 may also include one or more displays 104 for viewing. The displays 104 may permit a user to interact with the system 102 and its components and functions. This may be further facilitated by a user interface 106, which may include a mouse, joystick, or any other peripheral or control to permit user interaction with the system 102 and/or its devices. It should be understood that the components and functions of the system 102 may be integrated into one or more systems or workstations.

The system 102 may receive input 112, which may include, e.g., health care event data for a cohort of patients stored in electronic medical records (EMR) 114. The system 102 processes the health care event data to provide discriminative patterns as output 130. Health care event data may include patient demographics, physician notes, immunizations, radiology reports, etc. EMR 114 stores health care event data as medical events, such as, e.g., medications, labs, diagnoses, vital signs, etc., as well as patient outcomes. The cohort of patients may be segmented by patient outcomes, such as into, e.g., positive and negative outcomes. For example, patients not hospitalized for congestive heart failure one year after diagnosis may be a positive outcome, while patients hospitalized for congestive heart failure within one year after diagnosis may be a negative outcome. Other types of segmentation are also contemplated. A patient trace is constructed for each patient as a set of ordered events (e.g., chronologically) leading to a patient outcome. Each patient trace may include attributes for each event, such as, e.g., event names, event timestamps, etc.

Events in patient traces are collapsed (i.e., grouped) using identification module 116 and aggregation module 122. Identification module 116 is configured to identify groups of frequent events from the patient traces stored in EMR 114. In one embodiment, identifying groups of frequent events includes applying segmentation module 118 and clustering module 120. Other approaches are also contemplated. For example, identification module 116 may also identify clinical event packages from the patient traces using frequent itemset mining.

Segmentation module 118 is configured to perform event gap based trace segmentation (EGTS). For a set of patient traces, the ordering of events occurring within a short period of time may not be as important. For example, a patient may visit a physician, where tests are performed and medication is prescribed. The patient may either go to the lab first or the pharmacy first.

Segmentation module 118 segments each patient trace into a set of local event groups, such that events within the same group are treated equivalently (i.e., their temporal relationships can be ignored). The temporal relationships between each consecutive event are utilized to segment each patient trace into local event groups based upon a pre-defined gap threshold, such as, e.g., 120 minutes. The gap threshold is domain specific and may be specified from a user based on domain knowledge. In one example, a segmentation boundary may be placed between two consecutive events where the temporal gap (i.e., the time) between them is larger than the gap threshold.

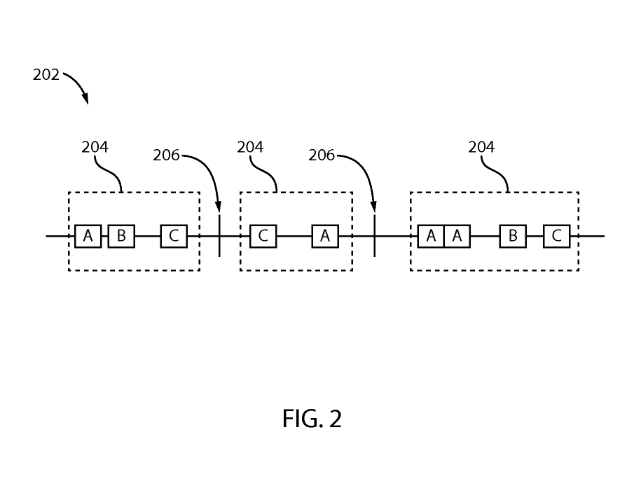

Referring for a moment to FIG. 2, event gap based trace segmentation is illustratively depicted in accordance with one embodiment. Events A, B and C are represented on patient trace 202. Where the temporal gap between consecutive events is larger than a gap threshold, segmentation boundaries 206 are placed between the events. Events between segmentation boundaries 206 are grouped as local event groups 204.

Referring back to FIG. 1, clustering module 120 is then configured to perform clustering based local event group collapse (LEGC). A set of frequent co-occurrence events is identified from the local event groups and collected into a co-occurrence dictionary. The co-occurrence dictionary includes each event from the local event groups with their frequency of appearance. Suppose there are n distinct events. An n by n event co-occurrence matrix is formed, with each row and each column corresponding to each event. The (i, j)-th entry is equal to the number of times that event i and event j co-occurred in those segments. Singular value decomposition is then performed on the co-occurrence matrix to identify the event clusters (i.e., the set of frequent co-occurrence events). Other forms of clustering may also be employed.

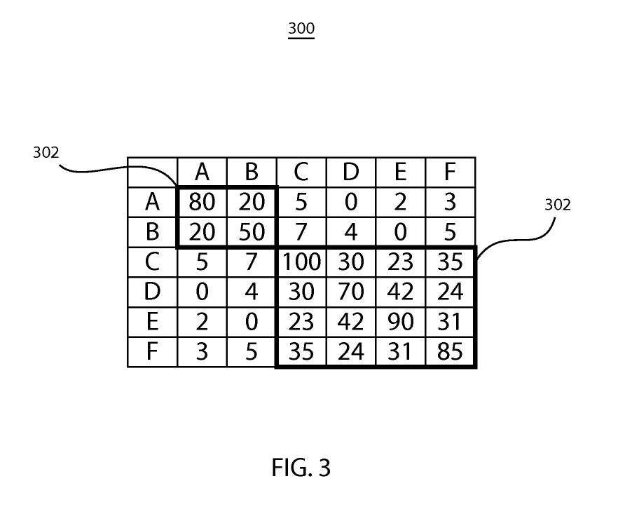

Referring for a moment to FIG. 3, a co-occurrence matrix 300 is illustratively depicted in accordance with one embodiment. Co-occurrence matrix 300 is formed for events ABCDEF, with each row and each column corresponding to each event. Each entry indicates the frequency of co-occurrence for the event indicated by the row and column of the co-occurrence matrix. Event clusters 302 are identified as AB and CDEF.

Referring back to FIG. 1, aggregation module 122 is configured to aggregate events in the segmented patient trace based upon the event cluster identified by identification module 116. In one embodiment, aggregation module 122 applies a two-way sorting technique. Event clusters are first identified in each segment of a patient trace. Identified event clusters are then sorted according to cardinality. Event clusters with a same cardinality are then sorted by appearance frequency. The event cluster with the longest cardinality is selected as a super event. Where multiple event clusters have the same longest cardinality, the event cluster with the same longest cardinality that has the highest appearance frequency is selected as the super event. This process is repeated for the remaining events in the patient trace, such that the number of events in a patient trace is reduced by grouping events as super events. Other event aggregation techniques are also contemplated.

Trace compacting module 124 then generates compact representations of the patient traces to further simplify the care pathway representation. In one embodiment, trace compacting module 124 performs repeating events elimination (REE) to consolidate consecutive identical events in a patient trace. Consecutive identical events may suggest some routine check or periodical treatment and therefore these events may be treated similarly. However, the temporal event patterns of repeating events are not as informative. It should be understood that the present principles are not limited to consolidating single events, but may also consolidate, e.g., consecutive identical super events (e.g., event clusters), etc.

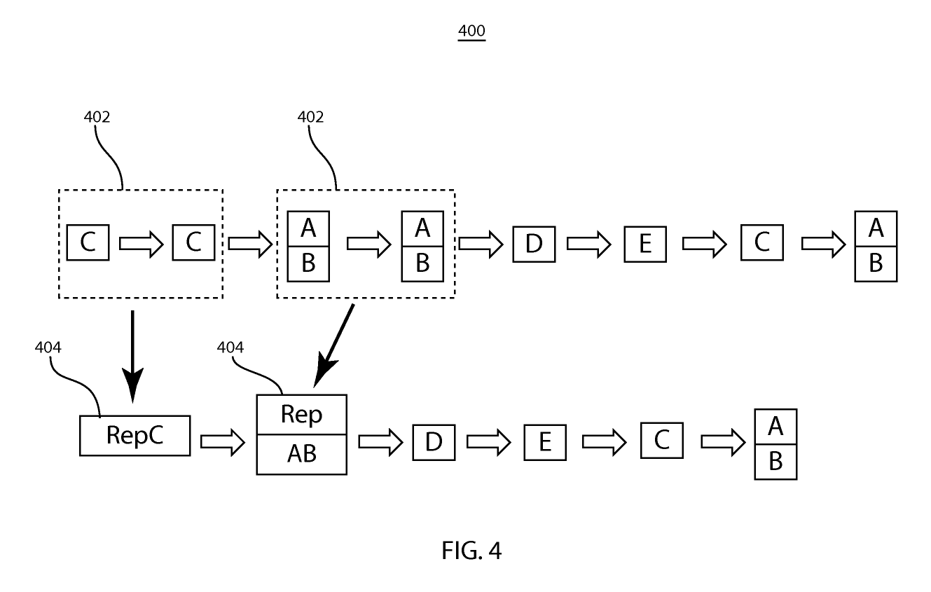

Referring for a moment to FIG. 4, consolidating consecutive identical events 400 is illustratively depicted in accordance with one embodiment. Consecutive identical events are identified as blocks 402 in a patient trace. Consecutive identical events 402 are consolidated as blocks 404 to eliminate event self-loops in the detected patterns. Although all repeating events can be treated equally, repeating events should be treated different from single events. Repeating events may be distinguished by, e.g., adding a prefix “Rep,” suffix “-Repeat,” etc. so that consecutive identical events C are consolidated as, e.g., RepC.

Referring back to FIG. 1, pattern processing module 126 is configured to perform pattern mining to identify frequent patterns from processed patient traces and determine correlations between patterns and outcomes. Frequent patterns are patterns that occur with a certain frequency among all patient traces. In one embodiment, pattern mining includes applying sequential pattern mining (SPAM). Other approaches are also contemplated, such as, e.g., prefix Scan, etc.

Pattern processing module 126 then processes the patterns to identify discriminative patterns. Each patient trace may be represented as a bag-of-pattern vector. Frequent patterns are organized into a pattern dictionary of a size m, where m is the number of different event patterns in the patient trace. The bag-of-pattern vector for each patient trace is an m-dimensional vector, where the value of the i-th dimension represents the frequency of occurrence of the i-th event corresponding to a patient trace.

Generally, pattern mining will return a large number of patterns. As such, the constructed bag-of-pattern representations may be very sparse, since most patterns do not occur most of the time. However, if vectors are too sparse, computational models may not be meaningful. Pattern processing module 118 applies hierarchical pattern summarization to compress the pattern set.

Hierarchical pattern summarization merges detected pattern pairs in a hierarchical (or recursive) way. If A→B is a detected pattern, and B→A is also a detected pattern, then the patterns A→B and B→A can be merged as a single pattern A;B and the order between them can be ignored. The bag-of-pattern vector of the resultant pattern frequency after merging is equal to the sum of the individual patterns it merged from. Hierarchical pattern summarization will repeat until there is nothing more to merge. It is noted that hierarchical pattern summarization is not limited to merging patterns of events, but may also include event clusters, etc.

Analysis module 128 is configured to apply, e.g., regression analysis for key action pattern identification. A bag-of-pattern matrix A may be formed from the bag-of-pattern vectors for each patient trace. The bag-of-pattern matrix A may be an n by m matrix, where n represents the number of patient traces and m represents the number of patterns. The (i,j)-th element of the matrix indicates the number of occurrences of the j-th pattern in the i-th patient trace. For each patient trace, a patient outcome measure (e.g., dead or alive, hospitalized or not, etc.) for each patient trace may be represented in an n dimensional outcome vector, with the i-th entry corresponding to the outcome of the i-th patient.

Sparse logistic regression may be applied to select a set of features (i.e., patterns) that are most predictive for the targets (i.e., outcomes). However, the computational complexity prevents its direct application where the number of features or data is too large. Therefore, analysis module 128 performs pre-filtering based on the correlation measures to filter out a set of patterns with low scores. Correlation measures may include, e.g., odds ratio, information gain, etc. Other correlation measures may also be employed.

Outcome analysis may be performed by analyzing columns in matrix A and an outcome vector. Specifically, each column in matrix A is an n dimensional vector, indicating the frequency distribution vector of the corresponding pattern. Correlation measures may be computed between columns in matrix A and the outcome vector, which serves as a quality score for each pattern.

In one embodiment, analysis module 128 may compute the odds ratio for one or more patterns. The odds ratio indicates the strength of association between a pattern and an outcome. The odds ratio is the ratio of the odds of an event occurring in one group (e.g., a pattern appearing) to the odds of it occurring in another group (e.g., an outcome occurring). For example, as illustrated in Table 1, the odds ratio may be computed as the ratio of the odds of a pattern appearing or not appearing, to the odds of a patient is hospitalized or not hospitalized. The odds ratio may be defined as in equation (1) as follows.

$$Odds Ratio = \frac{p 1 ( 1 - p 1 )}{p 2 / ( 1 - p 2 )} \qquad ( 1 )$$

TABLE 1
odds of a pattern appearing or not appearing for the outcome of
hospitalized or not hospitalized

| | Hospitalized | Not hospitalized |
|---|---|---|
| Pattern appear | p1 | p2 |
| Pattern did not appear | 1 − p1 | 1 − p2 |

In another embodiment, analysis module 128 may compute the information gain (also referred to as mutual information) between two events (e.g., pattern appearing and outcome). Information gain is the measure of mutual dependence between the two events. Information gain may be defined as in equation (2) as follows.

$$IG ( X , Y ) = H ( X ) - H ( X \vert Y ) \\ H ( X ) = - {\sum }_{i} P ( {x}_{i} ) {log}_{2} ( P ( {x}_{i} ) ) , \\ H ( X \vert Y ) = - {\sum }_{j} P ( {y}_{j} ) {\sum }_{i} P ( {x}_{i} \vert {y}_{j} ) {log}_{2} ( P ( {x}_{i} \vert {y}_{j} ) ) \qquad ( 2 )$$

where x represents the probability of a first event (i.e., pattern appearing) and yⱼ represents the probability of the j-th outcome.

Analysis module 128 then performs sparse logistic regression on the filtered set of patterns to identify patterns that are most predictive of outcomes, which may be included in output 130. The present principles relate temporal pattern mining to outcome analysis in the healthcare domain. For example, the present principles may be applied to extract care pathway patterns and determine whether they have any impact on positive or negative patient outcomes.

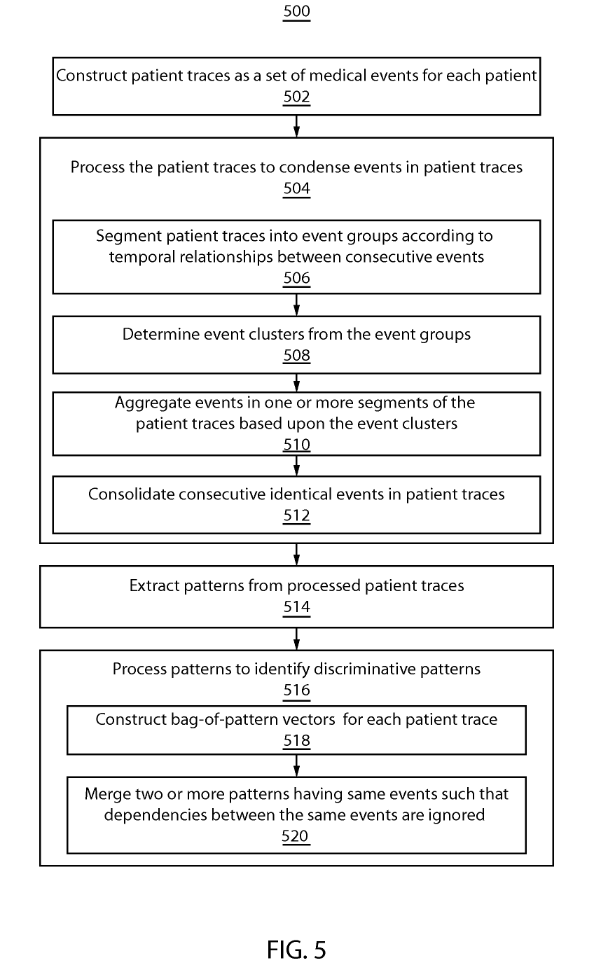

Referring now to FIG. 5, a block/flow diagram for a method for extracting key action patterns 500 is illustratively depicted in accordance with one embodiment. In block 502, patient traces are constructed as a set of medical events for each patient. Patient medical information may be stored as medical events, which may include, e.g., medications, labs, diagnoses, vital signs, etc. Patient outcomes corresponding to the patient traces may be segmented, e.g., into positive and negative outcomes.

In block 504, the patient traces are processed to collapse events in the patient traces. In block 506, patient traces are segmented into event groups according to temporal relationships between consecutive events. In one embodiment, segmentation boundaries are placed between two consecutive events in a patient trace based on a pre-defined gap threshold, such as, e.g., where the temporal gap between two consecutive events exceeds a pre-defined gap threshold. Event groups are provided as events between segmentation boundaries in a patient trace.

In block 508, event clusters are determined for the event groups. Preferably, each event for the event groups is collected in a co-occurrence dictionary, along with their frequency of appearance. A co-occurrence matrix is formed, with each event listed as both the row and column, such that the (i,j)-th entry is equal to the number of times that event i and event j co-occurred in those segments. In one embodiment, clustering with singular value decomposition is applied on the co-occurrence matrix to identify event clusters. Other methods of clustering may also be implemented.

In block 510, events in segments of patient traces are aggregated based upon the event clusters. Event clusters are first identified in a segment of a patient trace. Identified event clustered are sorted by cardinality, and within each group of event clusters having a same cardinality, identified event clusters are then sorted by frequency of appearance. The event cluster with the longest cardinality is selected as a super event. Where multiple event clusters have the same longest cardinality, the event cluster with the same longest cardinality that has the highest appearance frequency is selected as the super event. This method is repeated for the remaining portions of the patient trace. Events in a patient trace are thereby reduced by grouping events as super events.

In block 512, consecutive identical events are consolidated in patient traces. Preferably, the consolidated consecutive identical event is distinguished, e.g., by adding the prefix “Rep,” suffix “-Repeat,” etc.

In block 514, patterns are extracted from the processed patient traces. Preferably, extracting patterns includes performing pattern mining, such as, e.g., SPAM. In block 516, patterns are processed to identify discriminative patterns. In block 518, bag-of-pattern vectors are constructed for each patient trace. First, all patterns in a patient trace are collected in a pattern dictionary. A bag-of-pattern vector is formed such that the value of the i-th dimension represents the frequency of occurrence of the i-th event. In block 520, two or more patterns having same events are merged such that dependencies between the same events are ignored. The bag-of-pattern vector of the resultant pattern is equal to the sum of the individual patterns it merged from. This is repeated for all pattern pairs between the same events.

Regression analysis is then performed to identify discriminative patterns. Prior to performing sparse logistic regression, preprocessing is performed to reduce the number of patterns that are processed. A bag-of-pattern matrix is formed from the bag-of-pattern vectors, where patients indicate rows and action patterns indicate columns. Each entry indicates the number of occurrences of a pattern for a patient. An outcome vector may be formed indicating outcome for each patient. Preprocessing is performed by analyzing each column in the bag-of-pattern matrix with the outcome vector to provide a quality score for each pattern. Preprocessing preferably include, e.g., odds ratio, information gain, etc. Other preprocessing methods are also contemplated. Preprocessing results are used to filter the patterns. Sparse logistic regression is then performed on the filtered patterns to identify patterns that are most predictive of outcomes.

Having described preferred embodiments of a system and method for extracting key action patterns from patient event data (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for data analysis, comprising:
determining a patient trace as a set of medical events for a patient;
grouping medical events of the patient trace into subsets of medical events using a processor according to a temporal relationship between the medical events;
identifying co-occurring events from the subsets of medical events as event clusters; and
representing a plurality of medical events in one or more of the subsets of the patient trace using the event clusters to condense the patient trace.

2. The method as recited in claim 1, wherein grouping medical events includes grouping medical events of the patient trace into subsets of medical events according to a temporal threshold between consecutive medical events.

3. The method as recited in claim 2, wherein grouping medical events includes identifying segmentation boundaries between consecutive medical events according to the temporal threshold and providing events between the segmentation boundaries as the subsets of medical events.

4. The method as recited in claim 1, wherein identifying frequent co-occurring events includes forming a co-occurrence matrix with each medical event identifying rows and columns of the co-occurrence matrix, wherein entries of the co-occurrence matrix indicates a frequency of co-occurrence of the medical events indicated by the row and the column.

5. The method as recited in claim 4, wherein identifying frequent co-occurring events includes clustering the co-occurrence matrix to provide the frequent co-occurring events.

6. The method as recited in claim 1, further comprising consolidating consecutive medical events of a same type in the patient trace.

7. The method as recited in claim 6, wherein consecutive medical events of the same type include consecutive identical medical events.

8. The method as recited in claim 1, further comprising extracting patterns from the patient trace and merging two or more patterns having same events.

9. The method as recited in claim 8, wherein merging pairs of patterns includes disregarding dependencies between the same events of the pairs of patterns.

10-20. (canceled)
